(19) United States
(12) Patent Application Publication
(10) Pub. No.: US 2023/0348014 A1
(43) Pub. Date: Nov. 2, 2023

(54) ON-BOARD SYSTEM

(71) Applicant: YAMAHA HATSUDOKI KABUSHIKI KAISHA, Iwata-shi (JP)

(72) Inventor: Yutaka SARUWATARI, Shizuoka (JP)

(21) Appl. No.: 18/136,955

(22) Filed: Apr. 20, 2023

(30) Foreign Application Priority Data
Apr. 28, 2022 (JP) 2022-073950

(51) Int. Cl. B62J 43/13; B62J 50/22; B62J 43/30; B62M 6/45; B62M 6/90

(52) U.S. Cl. CPC B62M 6/45; B62J 43/13; B62J 43/30; B62J 50/22; B62M 6/90

(57) ABSTRACT

An on-board system includes electrical components mounted on a bicycle that have been individually identified. Each of the electrical components performs some functionality of the bicycle. At least one of the electrical components is detachable from the bicycle. The electrical components, when mounted on the bicycle, are electrically connected to each other. At least one of the electrical components includes a storage to store individual identification information about an authenticated electrical component. The functionality of the bicycle implementable by at least one of the electrical components mounted on the bicycle that have been individually identified varies depending on whether a combination of the individually identified electrical components matches the individual identification information about the authenticated electrical components stored in the storage.

### CROSS-REFERENCE TO RELATED APPLICATION

This application is based upon and claims the benefit of priority to Japanese Patent Application No. 2022-073950, filed on Apr. 28, 2022, the entire contents of which are hereby incorporated herein by reference.

### BACKGROUND OF THE INVENTION

### 1. Field of the Invention

The present invention relates to an on-board system for a bicycle.

### 2. Description of the Related Art

A bicycle with an electric system, such as an electric motor-assisted bicycle, for example, may include a plurality of electrical components. Examples of the electrical components include batteries, drive units, and meters. Further, the electrical components of a bicycle may include components that can be mounted on and detached from the bicycle. For example, a battery and a meter may be configured to be detachable by the user from the bicycle. Further, some of the electrical components of a bicycle may be replaceable by the user with other compatible electrical components.

Another problem is theft of electrical components. For example, because some electrical components are compatible, it may occur that only an electrical component is stolen and resold. To address this problem, for example, JP 2013-147123 A discloses an electrically driven vehicle that includes a theft prevention apparatus. The theft prevention apparatus includes a lock detection switch that detects a lock when the battery body has been fixed to the vehicle body, as well as an unlock; a mount detection switch that detects that the battery body has been mounted on the vehicle body; an alarm unit that issues an alarm; and a controller. The controller activates the alarm unit based on signals from the lock detection switch and mount detection switch.

### SUMMARY OF THE INVENTION

The inventor of preferred embodiments of the present invention discovered that the combination of electrical components of an on-board system of a bicycle can be set by the user freely to some degree. Based on this fact, the inventor discovered an arrangement that will deter theft of electrical components of a bicycle.

Preferred embodiments of the present application provide on-board systems for bicycles that are each able to deter theft of an electrical component of the bicycle.

An on-board system according to a preferred embodiment of the present invention includes a plurality of electrical components mounted on a bicycle that have been individually identified. Each of the plurality of electrical components performs some functionality of the bicycle. At least one of the plurality of electrical components includes a storage to store individual identification information about an authenticated electrical component. At least one of the plurality of electrical components is detachable from the bicycle. The plurality of electrical components, when mounted on the bicycle, are electrically connected to each other. Functionality of the bicycle implementable by at least one of the plurality of electrical components mounted on the bicycle that have been individually identified varies depending on whether a combination of the individually identified electrical components matches the individual identification information about the authenticated electrical component stored in the storage.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view of a bicycle according to a preferred embodiment of the present invention.

FIG. 2 is a functional block diagram illustrating an exemplary configuration of an on-board system according to a preferred embodiment of the present invention.

FIG. 3 is flow chart illustrating an exemplary operation of the on-board system shown in FIG. 2.

FIG. 4 shows exemplary individual identification information stored in a storage unit.

FIG. 5 is a flow chart illustrating another exemplary operation of the on-board system shown in FIG. 2.

FIG. 6 is a flow chart illustrating yet another exemplary operation of the on-board system shown in FIG. 2.

FIG. 7 illustrates how the ranges of functionality may be controlled by the function range control unit.

FIG. 8 is a flow chart illustrating an exemplary operation of an authentication setting unit of the on-board system shown in FIG. 2.

FIG. 9 illustrates the relationship between a condition in the process shown in FIG. 8 and an authentication process.

### DETAILED DESCRIPTION OF THE PREFERRED EMBODIMENTS

An on-board system according to a preferred embodiment of the present invention includes a plurality of electrical components mounted on a bicycle that have been individually identified. Each of the plurality of electrical components performs some functionality of the bicycle. At least one of the plurality of electrical components is detachable from the bicycle. The plurality of electrical components, when mounted on the bicycle, are electrically connected to each other. At least one of the plurality of electrical components includes a storage unit to store individual identification information about an authenticated electrical component. Functionality of the bicycle implementable by at least one of the plurality of electrical components mounted on the bicycle that have been individually identified varies depending on whether a combination of these electrical components matches the individual identification information about the authenticated electrical component stored in the storage unit.

In the preferred embodiment described above, the functionality of the bicycle that can be implemented by the electrical components mounted on the bicycle that have been individually identified varies depending on whether the combination of these electrical components matches the individual identification information about the authenticated electrical component stored in the storage unit. Thus, when a combination of electrical components that have not been authenticated are mounted, the functionality of the bicycle is different from that when a combination of authenticated electrical components are mounted. This will deter theft of electrical components of a bicycle. For example, if a combination of a plurality of electrical components mounted on the bicycle does not match individual identification information about an authenticated electrical component stored in the storage unit, the functionality of the bicycle that can be implemented by the electrical components may be restricted or augmented relative to that in the case of a match. In such implementations, an electrical component stolen and mounted on another bicycle does not enable this bicycle to exhibit its predetermined functionality, or causes the bicycle to exhibit redundant functionality. This will deter theft of electrical components.

In the preferred embodiment described above, each of the electrical components may store individual identification information about an authenticated electrical component or may store individual identification information for individual identification of itself. As individual identification information of each of the combined electrical components mounted on the bicycle can be shared among the electrical components mounted, at least one of the electrical components may determine whether the combined electrical components are authenticated individual components.

Further, in the preferred embodiment described above, it is unnecessary to communicate with an external device (e.g., authentication server) over a network in order to determine whether the mounted electrical components are authenticated or not. This eliminates the necessity to build network-based infrastructure for authentication. This will provide an on-board system able to efficiently deter theft using electrical components mounted on the bicycle without relying on network communication.

Starting from the preferred embodiment described above, if the combination of the plurality of electrical components mounted on the bicycle that have been individually identified does not match the individual identification information about the authenticated electrical components stored in the storage unit, the functionality of the bicycle implementable by at least one of the plurality of electrical component may be restricted relative to that in a case of a match. Thus, the functionality of a stolen electrical component of the bicycle is restricted. This will further deter theft. The functionality to be restricted may be a function relating to traveling of the bicycle, for example.

By way of example, in another preferred embodiment, the functionality of the bicycle may be restricted if an electrical component mounted on the bicycle that has been individually identified is different from the electrical component specified by the individual identification information about the authenticated electrical component, or if an electrical component specified by individual identification information about an authenticated electrical component has been removed from the bicycle and is not mounted anymore.

Starting from one of the preferred embodiments described above, at least one of the plurality of electrical components may include an authentication unit to determine whether the combination of the plurality of electrical components mounted on the bicycle that have been individually identified matches the individual identification information about the authenticated electrical component stored in the storage unit, and a function range control unit to control a range of a function implemented by at least one of the plurality of electrical components based on the determination by the authentication unit. This will efficiently achieve restricted functionality based on the combination of the mounted electrical components. It will be understood that the authentication unit and the function range control unit may be provided in one electrical component, or may be distributed among two or more electrical components.

The authentication unit may be provided in a non-detachable one of the plurality of electrical components, for example. The authentication setting unit may be provided in a non-detachable one of the plurality of electrical components, for example. The storage unit that stores the individual identification information about the authenticated electrical component may be provided in a non-detachable one of the plurality of electrical components, for example.

Individual identification refers to uniquely identifying one specific existing component. For example, a plurality of components of the same device type are identified as different individual components. Individual identification may be performed by an individual identifier, for example. Further, for example, if one component contains the entity that identifies individual components mounted on the bicycle, this component may be treated as an already identified one.

The authentication unit may perform the determination by obtaining information specifying the plurality of electrical components mounted on the bicycle and comparing this information with the individual identification information about the authenticated electrical component stored in the storage unit.

For example, the authentication unit may obtain an individual identifier of at least a detachable one of the plurality of electrical components mounted on the bicycle. The authentication unit may determine whether the combination of the plurality of electrical components mounted on the bicycle that have been individually identified matches the individual identification information about the authenticated electrical component stored in the storage unit by comparing the individual identifier of the detachable electrical component with the individual identification information about the authenticated electrical component.

Starting from one of the preferred embodiments described above, at least one of the plurality of electrical components may include an authentication setting unit to record, in the storage unit, individual identification information about a new authenticated electrical component when a user has performed a predetermined operation. This will enable the user to set an authenticated electrical component.

Starting from one of the preferred embodiments described above, the authentication setting unit may control recording, in the storage unit, of the new individual identification information about the authenticated electrical component based on at least one of the combination of the plurality of electrical components mounted on the bicycle that have been individually identified or the individual identification information about the authenticated electrical component stored in the storage unit. This control to record an authenticated electrical component will restrict using an authenticated electrical component in a stolen component or bicycle. This will yet further deter theft.

Starting from one of the preferred embodiments described above, if the user has performed the predetermined operation when the individual identification information about the authenticated electrical component was not stored in the storage unit, the authentication setting unit may record in the storage unit the individual identification information about the new authenticated electrical component. In such implementations, if the user has performed the predetermined operation when the individual identification information about the authenticated electrical component was stored in the storage unit, the authentication setting unit may be configured not to permit recording of the individual identification information about the new authenticated electrical component. Thus, after authenticated electrical components are set at an early stage, e.g., when an as-shipped bicycle is purchased, setting of an authenticated electrical component by the user is restricted. This will yet further deter theft.

Starting from one of the preferred embodiments described above, the authentication setting unit may permit the storage unit to update the individual identification information about the authenticated electrical component based on a condition that the user has performed a predetermined setting operation when the combination of the plurality of electrical components mounted on the bicycle that have been individually identified matches the individual identification information about the authenticated electrical component stored in the storage unit. This restricts updating of a setting by the user when authenticated electrical components have already been set. This will yet further deter theft. The predetermined setting operation may be the same as the predetermined operation, or may be different therefrom. Updating of the individual identification information about the authenticated electrical component may be at least one of deletion or addition of individual identification information about an authenticated electrical component, for example.

The plurality of electrical components may include at least two of a motor drive, a display unit to display a state of the bicycle, an operator to receive an input by a user for the bicycle, a headlight, and a battery.

A preferred embodiment of the present invention includes a drive unit of the motor representing one of the plurality of electrical components in the on-board system of any one of the preferred embodiments described above. The drive unit of the motor may be configured to vary the functionality of the bicycle implementable by driving of the motor depending on whether the combination of the plurality of electrical component mounted on the bicycle that have been individually identified matches the individual identification information about the authenticated electrical components stored in the storage unit.

The drive unit is electrically interconnected with another electrical component mounted on the bicycle. At least one of the drive unit or the other electrical component includes a storage unit to store individual identification information about an authenticated electrical component. The functionality of the bicycle implementable by at least one of driving of the motor varies depending on whether the combination of the drive unit mounted on the bicycle and the other electrical component mounted on the bicycle that has been individually identified matches the individual identification information about the authenticated electrical component stored in the storage unit. The functionality of the bicycle may be defined by the range of propulsion assistance in the bicycle that can be implemented by driving of the motor, for example. By way of example, in the case of a non-match, the function of propulsion assistance in the bicycle implemented by driving of the motor may be restricted, or redundant assist function may be added. The drive unit may include the authentication unit and the function range control unit, for example. The function range control unit may control the range of propulsion assist function implemented by driving of the motor.

A preferred embodiment of the present invention includes the display unit to display a state of the bicycle that represents one of the plurality of electrical components in the on-board system of any one of the preferred embodiments described above. The display unit may be configured to vary the functionality of the bicycle implementable by at least one of the plurality of electrical components depending on whether the combination of the plurality of electrical components mounted on the bicycle that have been individually identified matches the individual identification information about the authenticated electrical component stored in the storage unit.

The display unit is electrically interconnected with another electrical component mounted on the bicycle. At least one of the display unit or the other electrical component includes a storage unit to store individual identification information about an authenticated electrical component. The functionality of the bicycle implementable by at least one of the plurality of electrical components varies depending on whether the combination of the display unit and the other electrical component mounted on the bicycle that have been individually identified matches the individual identification information about the authenticated electrical component stored in the storage unit. The functionality of the bicycle may be defined by the range of information to be displayed by the display unit, for example. By way of example, in the case of a non-match, the number of items to be displayed by the display unit about the state of the bicycle or for receiving an operation may be restricted, or redundant display items may be added. The display unit may include the authentication unit and the function range control unit, for example. The function range control unit may control the range of information to be displayed by the display unit.

A preferred embodiment of the present invention includes a battery that represents one of the plurality of electrical components in the on-board system of any one of the preferred embodiments described above. The battery may be configured to vary electric power to be supplied to at least one of the plurality of electrical components depending on whether the combination of the plurality of electrical components mounted on the bicycle that have been individually identified matches the individual identification information about the authenticated electrical component stored in the storage unit. This will enable varying the functionality of the bicycle implementable by at least one of the plurality of electrical components.

The battery is electrically interconnected with another electrical component mounted on the bicycle. At least one of the battery or the other electrical component includes a storage unit to store individual identification information about an authenticated electrical component. The electric power to be supplied by the battery to at least one of the plurality of electrical components varies depending on whether the combination of the display unit and the other electrical component mounted on the bicycle that have been individually identified matches the individual identification information about the authenticated electrical component stored in the storage unit. The battery may include the authentication unit and the function range control unit, for example. The function range control unit may control the range of electric power to be output by the battery.

A preferred embodiment of the present invention includes a headlight representing one of the plurality of electrical components in the on-board system of any one of the preferred embodiments described above. For example, the function of the headlight may vary depending on whether the combination of the headlight and the other electrical component mounted on the bicycle that have been individually identified matches the individual identification information about the authenticated electrical component stored in the storage unit. For example, when the combination of the headlight and the other electrical component mounted on the bicycle that have been individually identified does not match the individual identification information about the authenticated electrical component, the illumination function of the headlight may be reduced, or the headlight may rapidly flash on and off. This will make it difficult to continue to use the stolen headlight or bicycle. As a result, theft will be further deterred.

A preferred embodiment of the present invention includes the bicycle including the on-board system of any one of the preferred embodiments described above. By way of example, the bicycle may be an electric motor-assisted bicycle. The electric motor-assisted bicycle may include: a torque sensor to detect a pedaling force on a pedal connected to a crankshaft of the electric motor-assisted bicycle, a motor to generate an assist force to assist the pedaling force, and a control device configured or programmed to control the assist force of the motor depending on the pedaling force. In such implementations, one of the plurality of electrical components may be the drive unit, for example. The drive unit may include the torque sensor, the motor, and the control device. The drive unit may be a non-detachable electrical component, for example.

The electrical component detachable from the bicycle is an electrical component that is detachable during normal use of the bicycle by the user. For example, a drive unit that has been mounted on the bicycle in such a manner that the crankshaft of the bicycle extends therethrough may be removed from the bicycle by using a special tool to dismantle it. However, such a drive unit cannot be considered to be detachable during normal use by the user.

Implementations in which a plurality of electrical components are electrically connected include implementations in which at least two of the plurality of electrical components are connected by a cable or wirelessly connected, for example.

Now, a bicycle according to a preferred embodiment of the present invention will be described with reference to the drawings. In the drawings, the same or corresponding elements are labeled with the same reference numerals, and their description will not be repeated. Further, the sizes of the components in the drawings do not exactly represent the sizes of the actual components, the size ratios between the components, or the like. In the description provided below, the directions “front/forward” and “rear(ward)”, “left” and “right”, and “top/up(ward)” and “bottom/down(ward)” with respect to the bicycle refer to such directions as perceived by a rider (i.e., user) sitting on the saddle (i.e., seat) and gripping the handlebars. The directions “front/forward” and “rear(ward)”, “left” and “right”, and “top/up(ward)” and “bottom/down(ward)” with respect to the bicycle are the same as such directions with respect to the vehicle body, i.e., vehicle-body frame of the bicycle. Furthermore, the forward direction of the bicycle is the same as the front-rear direction of the bicycle. The preferred embodiments described below are merely illustrative, and the present invention is not limited to these preferred embodiments.

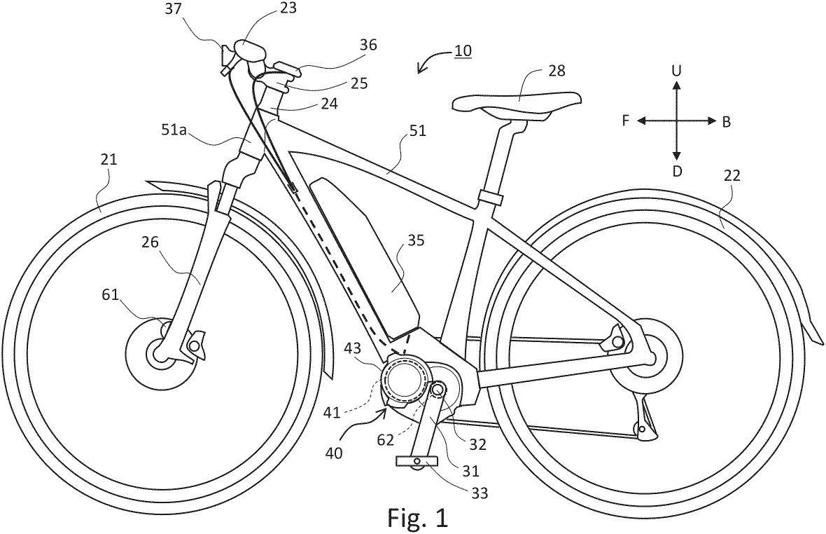

FIG. 1 is a left side view of a bicycle 10 according to a preferred embodiment of the present invention. The characters “F”, “B”, U″ and “D” in FIG. 1 refer to forward, rearward, upward, and downward, respectively.

As shown in FIG. 1, the bicycle 10 includes a vehicle-body frame 51. The vehicle-body frame 51 extends in the front-rear direction. The vehicle-body frame 51 includes a head pipe 51a located toward the front. The head pipe 51a rotatably supports a steering shaft 24. Handlebars 23 are attached to the top of the steering shaft 24 with a stem 25 provided therebetween. A front fork 26 is attached to the bottom of the steering shaft 24 to rotatably support a front wheel 21.

A seat 28 is attached to the vehicle-body frame 51. A rear wheel 22, located rearward of the seat 28, is rotatably supported on a rear portion of the vehicle-body frame 51. A crankshaft 32 is rotatably supported by the vehicle-body frame 51. Crank arms 31 and pedals 33 are attached to the crankshaft 32. The bicycle 10 includes a transmission mechanism that transmits rotation of the crankshaft 32 to the rear wheel 22.

A torque sensor 62 is provided around the crankshaft 32 to detect a pedaling force by the user (i.e., rider). The torque sensor 62 detects a torque that rotates the crankshaft 32 about its axis. The torque sensor 62 may, for example, be a noncontact torque sensor, such as a magnetostrictive sensor, or a contact torque sensor, such as an elastic-body variable detector. The magnetostrictive torque sensor includes a magnetostrictive member with magnetostrictive effect that receives a rotational force of the crankshaft and a detection coil that detects changes in magnetic permeability due to forces from the magnetostrictive member.

A battery 35 and a drive unit 40 are mounted on the vehicle-body frame 51. The battery 35 supplies the drive unit 40 with electric power. The battery 35 is detachable from the vehicle-body frame 51. The battery 35 and the drive unit 40 are electrically connected by a cable, for example.

The drive unit 40 includes a housing 43 as well as a motor 41 and a control device (not shown in FIG. 1) contained in the housing 43. The motor 41 generates an assist force to assist the pedaling force by the user. The control device controls the assist force by the motor 41 depending on the pedaling force detected by the torque sensor 62. The control device includes, for example, an inverter that controls the motor 41 and a computing unit, such as a microcontroller unit (MCU) or micro-processing unit (MPU), that calculates command values for the motor 41.

Rotation of the motor 41 is transmitted by the transmission mechanism to the rear wheel 22. The transmission mechanism includes, for example, a synthesizing mechanism that synthesizes rotation of the motor 41 and rotation of the crankshaft 32, and a synthesized-force transmission mechanism that transmits the synthesized force to the rear wheel.

A display unit 36 is mounted around the handlebars 23. The display unit 36 displays a state of the bicycle 10. The display unit 36 includes a display device such as a display or a lamp. Further, the display unit 36 may include an input device, such as a switch or a touch screen, that receives user input for the bicycle 10. Thus, the display unit 36 may be integrated with the operation unit. Alternatively, an operation unit may be provided separately from the display unit 36. The operation unit includes, for example, an input device such as a switch or a button, and a conversion unit that converts operations on the input device into electric signals. It will be understood that the display unit 36 and the operation unit may be mounted on the handlebars 23, the stem 25, the steering shaft 24 or the vehicle-body frame 51, for example. The display unit 36 is attached to a location that is visible and operable for the user. The display unit 36 may be detachable from the bicycle 10. For example, the display unit 36 may be detachable from a cradle (i.e., holder) mounted on the bicycle 10. The cradle may include the operation unit.

The bicycle 10 includes a headlight 37. In the implementation shown in FIG. 1, the headlight 37 is attached to the handlebars 23; alternatively, the headlight may be attached to other locations, such as the front fork 26. The headlight 37 may be detachable from the bicycle 10. For example, the headlight 37 may be detachable from a cradle (i.e., holder) mounted on the bicycle 10.

In the implementation shown in FIG. 1, a vehicle-speed sensor (i.e., speed sensor) 61 is provided on the front fork 26 to detect rotation of the front wheel 21. The vehicle-speed sensor 61 includes, for example, a detected element that rotates together with the front wheel 21, and a detecting element fixed to the vehicle-body frame 51 to detect rotation of the detected element. The detecting element detects the detected element in a mechanical, magnetic, or optical manner. Alternatively, the vehicle-speed sensor 61 may detect rotation of a rotating body other than the front wheel 21 that rotates as the bicycle 10 advances, such as the rear wheel 22, motor 41, crankshaft 32, transmission gear, or chain, for example. The bicycle 10 may include, in addition to the vehicle-speed sensor, a sensor that detects a state of the vehicle. The bicycle 10 may include, for example, an angular velocity sensor (i.e., gyrosensor), or an acceleration sensor. Alternatively, the bicycle 10 may include a crankshaft rotation sensor that detects rotation of the crankshaft 32.

The battery 35, the display unit 36, the headlight 37, and the drive unit 40 are electrically connected. Thus, electric power from the battery 35 may be supplied to the drive unit 40, the display unit 36, and the headlight 37. For example, the battery 35 may be directly connected to the display unit 36, the headlight 37, and the drive unit 40, or may be connected to the display unit 36 and the headlight 37 via the drive unit 40 positioned in between.

Further, the drive unit 40 is configured to be able to communicate with the battery 35, the display unit 36, and the headlight 37. The communication may use a cable, or may be wireless. In the present implementation, the drive unit 40 serves as a hub of communication between the electrical components; however, the network configuration between the electrical components (i.e., network topology) is not limited to such a configuration. For example, the display unit 36 may serve as a hub. Alternatively, a star-type configuration having a hub may be replaced by a bus-type, a ring-type, a full-mesh-type, or any other type of network configuration.

The display unit 36 and the drive unit 40 are electrically connected via a cable (i.e., electric wire), for example. For example, a cradle that allows the display unit 36 to be mounted thereon and detached therefrom may be connected to the drive unit 40 via a cable. In such implementations, the cradle and the display unit 36 mounted on the cradle may be electrically connected via a cable or connected wirelessly. For example, when the display unit 36 is mounted on the cradle, the display unit 36 is electrically connected to the control device of the drive unit 40 via a terminal on the cradle and the cable. Similarly, the drive unit 40 may be connected to the headlight 37 via a cable and a terminal on a cradle. The drive unit 40 and the battery 35 may also be electrically connected via a cable and connection terminals.

The display unit 36 may be electrically connected to a sensor included in the bicycle 10, such as the vehicle-speed sensor 61. The display unit 36 and the sensor may be connected via a cable, or may be wirelessly connected. It will be understood that at least a portion of the cable connected to the display unit 36 may extend through the interior of the vehicle-body frame 51. The display unit 36 may be electrically connected to another electrical component, such as the headlight 37.

In the implementation shown in FIG. 1, the control device is incorporated in the housing 43 of the drive unit 40. In a variation, the control device may be located outside the housing 43. For example, the control device may be located on the handlebars 23, stem 25, steering shaft 24, or cradle (i.e., holder) mounted on the vehicle-body frame 51.

In the implementation shown in FIG. 1, the battery 35, the display unit 36, the headlight 37, and the drive unit 40 represent some of the plurality of electrical components in the on-board system. By way of example, the display unit 36, the headlight 37, and the battery 35 are detachable electrical components that are detachable from the bicycle 10. The drive unit 40 is a fixed-to-vehicle electrical component that is fixed to the bicycle 10 and is non-detachable.

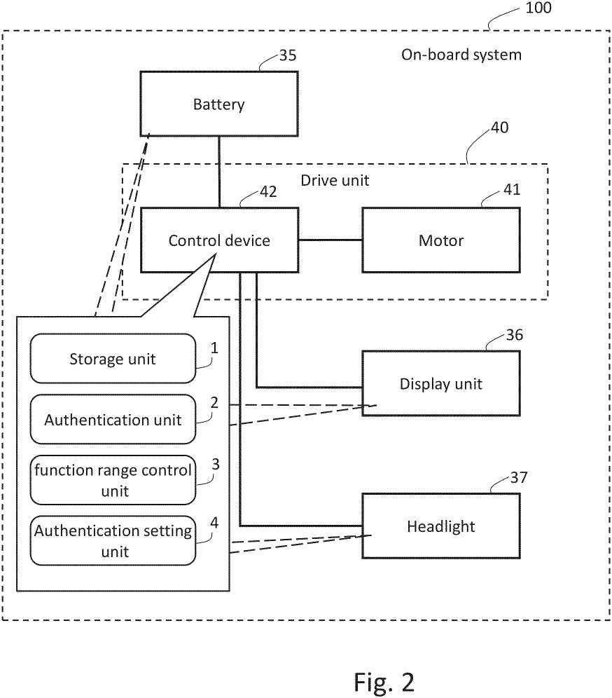

FIG. 2 is a functional block diagram illustrating an exemplary configuration of an on-board system 100 of the bicycle 10. In the implementation shown in FIG. 2, the on-board system 100 includes a plurality of electrical components, for example, the battery 35, the display unit 36, the headlight 37, and the drive unit 40. The drive unit 40 includes the motor 41 and the control device 42. The battery 35 is electrically connected to the control device 42. The control device 42 is electrically connected to the motor 41, the display unit 36, and the headlight 37.

The control device 42 controls the motor 41. For example, the control device 42 controls the motor 41 depending on a pedaling force detected by the torque sensor 62. Thus, the system exhibits an assist function which assists the user in pedaling. In addition to or in lieu of a pedaling force from the torque sensor 62, the control device 42 may rely on information obtained through detection by the vehicle-speed sensor 61 or other sensors, to control the motor 41. The control device 42 may control the motor 41 in a specified one of a plurality of modes of running. A mode of running is a mode of assist control. Each mode of running defines how to decide on an assist force by the motor depending on pedaling force and/or other conditions (e.g., vehicle speed), for example. Switching among modes of running changes the manner in which to decide on an assist force depending on pedaling and/or other conditions.

The control device 42 may control input/output of electric power into/from the drive unit 40. For example, the control device may supply electric power supplied from the battery 35 to the motor 41 and, in addition, to the display unit 36 and the headlight 37. The headlight 37 uses electric power supplied from the battery 35 to emit light to illuminate a space in front of the bicycle 10. It will be understood that the headlight 37 may incorporate a battery. Light from the headlight 37 may be switched on and off by user operation, or may be automatically switched depending on detection results from optical sensors.

The display unit 36 displays a state of the bicycle 10. The display unit 36 receives information from electrical components such as the control device 42 and from sensors provided on the bicycle 10 and, based on this information, generates information indicating a state of the bicycle 10 and displays it. A state of the bicycle 10 displayed on the display unit 36 may be a state relating to traveling of the bicycle 10. For example, the display unit 36 may display a running distance (ODO, TRIP), a vehicle speed, a mode of running, a remaining capacity of the battery, a remaining distance the system can provide assistance, a state of an electrical component (i.e., failure diagnosis, etc.).

The display unit 36 may include an operation unit that receives user operations. In such implementations, the display unit 36 transmits a user operation on the operation unit, or an action command associated with the operation, to the control device 42 of the drive unit 40. The control device 42 transmits, to the display unit 36, information indicating pedaling force, crankshaft rotation, vehicle speed or other states of the bicycle. The display unit 36 displays the information transmitted from the control device 42.

Thus, the electrical components of the on-board system 100 implement various functions of the bicycle 10. The on-board system 100 of FIG. 2 varies the ranges of the functions of the bicycle 10 implementable by at least one of the plurality of electrical components mounted on the bicycle 10 depending on whether the combination of the electrical components is an authenticated combination. Accordingly, at least one of the electrical components includes a storage unit 1, an authentication unit 2, a function range control unit 3, and an authentication setting unit 4. Each of these functional units may be concentrated in one electrical component, or may be distributed among a plurality of electrical components. In FIG. 2, by way of example, the control unit 42, which is one of the fixed-to-vehicle electrical components, includes a storage unit 1, an authentication unit 2, a function range control unit 3, and an authentication setting unit 4.

The storage unit 1 is a storage device that stores individual identification information about one or more authenticated electrical components. The storage unit 1 may be, for example, a non-volatile memory (by way of example, EEPROM) able to maintain stored information without power supply. In this case, information in the storage unit 1 is held even when the on-board system 100 is powered off. Alternatively, the storage unit 1 may be a volatile memory if it can constantly receive power supply from the battery 35 or other batteries.

The authentication unit 2 determines whether the combination of the plurality of electrical components mounted on the bicycle 10 that have been individually identified matches the individual identification information about the authenticated electrical component(s) stored in the storage unit 1. The authentication unit 2 obtains individual identification information about the electrical components mounted on the bicycle 10 and compares it with the individual identification information about the authenticated electrical component(s) stored in the storage unit 1. The result of comparison output by the authentication unit 2 may be, for example, information indicating whether the result is a match (i.e., a match or a non-match), or information indicating that no individual identification information about an authenticated electrical component is stored in the storage unit 1.

At least those of the electrical components mounted on the bicycle 10 that exclude the electrical component including the authentication unit 2 (i.e., the other electrical components) may each store their own individual identification information. In such implementations, the authentication unit 2 communicates with the other electrical components mounted on the bicycle 10 to obtain the individual identification information about the other electrical components. The authentication unit 2 determines whether the obtained individual identification information about the other electrical components matches the individual identification information about the authenticated electrical components stored in the storage unit 1. Thus, the unit determines whether the combination of the electrical components mounted on the bicycle 10 is an authenticated combination.

If the determination by the authentication unit 2 indicates a match, this means that the combination of electrical components mounted on the bicycle 10 is an authenticated combination. If the determination by the authentication unit 2 indicates a non-match, this means that the combination of electrical components mounted on the bicycle 10 is not an authenticated combination. The determination indicates a non-match if, for example, one of the combined authenticated electrical components is not mounted on the bicycle 10, i.e. has been removed therefrom, or if an electrical component that has not been authenticated is mounted on the bicycle 10.

The authentication unit 2 is not limited to an arrangement that obtains individual identification information about other electrical components and determines whether the individual identification information obtained matches individual identification information about authenticated electrical components. For example, the authentication unit 2 may be configured to receive a result of comparison between combined individual identification information about the mounted electrical components and individual identification information about authenticated electrical components and make a determination based on the comparison.

Based on the determination by the authentication unit 2, the function range control unit 3 controls the range of the function to be implemented by at least one of the plurality of electrical components. The function range control unit 3 controls at least one electrical component such that the range of the function to be implemented by that at least one of the plurality of electrical components mounted on the bicycle 10 varies depending on whether the determination by the authentication unit 2 indicates a match or a non-match. Thus, the functionality of the bicycle 10 implementable by the plurality of electrical components vary depending on the determination by the authentication unit 2. For example, the function range control unit 3 may change the setting of a parameter used during operation of an electrical component to change the range of the function to be implemented by that electrical component.

For example, when the determination indicates a non-match, the function range control unit 3 may, for example, restrict the functions implementable by the plurality of electrical components relative to the functions implementable when the determination indicates a match. This restricts the functionality to be implemented by a bicycle 10 on which an electrical component that has not been authenticated, such as a stolen electrical component, is mounted, for example. As a result, theft will be deterred. In other implementations, when the determination indicates a non-match, the function range control unit 3 may render redundant the functions to be implemented by the plurality of electrical components relative to the functions implementable when the determination indicates a match. Examples of redundant functions include an extremely unpleasant assist by the drive unit 40 or rapid flashing on and off of the headlight 37. Redundant functions exhibited by the system serve as a resistance to continued use of the stolen electrical component. As a result, theft will be deterred.

The authentication setting unit 4, upon the user performing a predetermined operation for authentication, records individual identification information about (an) authenticated electrical component(s) in the storage unit 1. The predetermined operation is an operation by the user on the bicycle 10, and is a predetermined operation. For example, the predetermined operation may be an operation that cannot occur during normal use of the bicycle 10, such as pressing and holding a predetermined switch for longer than a predetermined period of time. This enables the user to register a combination of authenticated electrical components.

When the authentication setting unit 4 detects that the user has performed a predetermined operation on the bicycle 10, the unit obtains the individual identification information about the electrical component(s) mounted on the bicycle 10 at the time of that operation and records it as the individual identification information about the authenticated electrical component(s) in the storage unit 1. Thus, the individual identification information about the authenticated electrical component(s) is registered. At this time, the authentication setting unit 4 may permit recording of the individual identification information about the authenticated electrical component(s) only if a predetermined condition for authentication is met. For example, the condition for authentication may be based on at least one of (A) the combination of the plurality of electrical components mounted on the bicycle that have been individually identified, or (B) the individual identification information about the authenticated electrical component(s) stored in the storage unit 1.

For example, if a user can register an authenticated electrical component on the bicycle 10 very easily, a stolen electrical component may be easily used as an authenticated electrical component for another bicycle. In other cases, a bicycle from which a detachable electrical component has been removed may be stolen and an electrical component for another individual bicycle may be easily mounted on the stolen bicycle to serve as an authenticated electrical component. In view of this, it is preferable that registration of individual identification information about an authenticated electrical component by the user is restricted by a predetermined condition.

For example, if an authenticated electrical component is already present, i.e., if individual identification information about an authenticated electrical component is already stored in the storage unit 1, the authentication setting unit 4 may not update the authentication information (i.e., individual identification information about the authenticated electrical component) in the storage unit 1 even when the user has performed a predetermined operation. On the other hand, if the user performs a predetermined operation when no authentication information is present, such as when the bicycle 10 is in an initial state upon shipment, i.e., when no individual identification information about an authenticated electrical component is stored in the storage unit 1, then, the authentication setting unit 4 may record in the storage unit 1 individual identification information about the electrical components that are mounted on the bicycle 10 at this time as individual identification information about authenticated electrical components.

The user may wish to change the combination of authenticated electrical components. For example, the user may wish to replace a battery that has been used numerous times and has deteriorated in performance. In this case, for example, with a combination of authenticated electrical components mounted on the bicycle 10, a new combination of electrical components may be registered as an authenticated combination under a condition that the user performs the operation of deleting (i.e., resetting) the existing individual identification information about the authenticated electrical components (an example of a predetermined setting operation). In this case, the existing individual identification information about the authenticated electrical components is deleted such that no individual identification information about an authenticated electrical component is stored in the storage unit 1. In this state, the user removes the existing battery and mounts a new battery on the bicycle 10. When the user performs a predetermined operation for authentication with a combination of electrical components including the new battery mounted on the bicycle 10, the combination of electrical components including the new battery is recorded in the storage unit 1 as an authenticated combination.

Further, the user may wish to add a combination of authenticated electrical components. For example, the user may wish to use a plurality of batteries and use them alternately, one after another. In this case, for example, with a combination of authenticated electrical components mounted on the bicycle 10, a new electrical component may be additionally registered as an authenticated electrical component based on a condition that the user performs a specified setting operation to obtain permission to add individual identification information about an authenticated electrical component (an example of a predetermined setting operation). That is, with a combination of authenticated electrical components mounted on the bicycle 10, the user may perform a specified setting operation to obtain permission such that the authentication setting unit 4 is ready to add a new individual component as an authenticated electrical component in addition to the currently held authenticated electrical components. Thereafter, the user may mount the new battery that the user intended to add and, with a combination of electrical components including the new battery mounted on the bicycle 10, perform a predetermined operation for authentication such that the authentication setting unit 4 additionally records in the storage unit 1 individual identification information about this battery as individual identification information about an authenticated electrical component.

Thus, providing a restriction on setting of an authenticated combination of electrical components prevents unauthorized authentication by a third party. This will yet further deter theft. At the same time, the user will be able to set an authenticated combination of electrical components as desired.

The authentication unit 2, function range control unit 3, and authentication setting unit 4 may include a computer or an electronic circuit included in at least one of the plurality of electrical components. The functions of the authentication unit 2, function range control unit 3, and authentication setting unit 4 may be implemented, for example, by a processor executing a predetermined program, or may be implemented by operation of an electronic circuit.

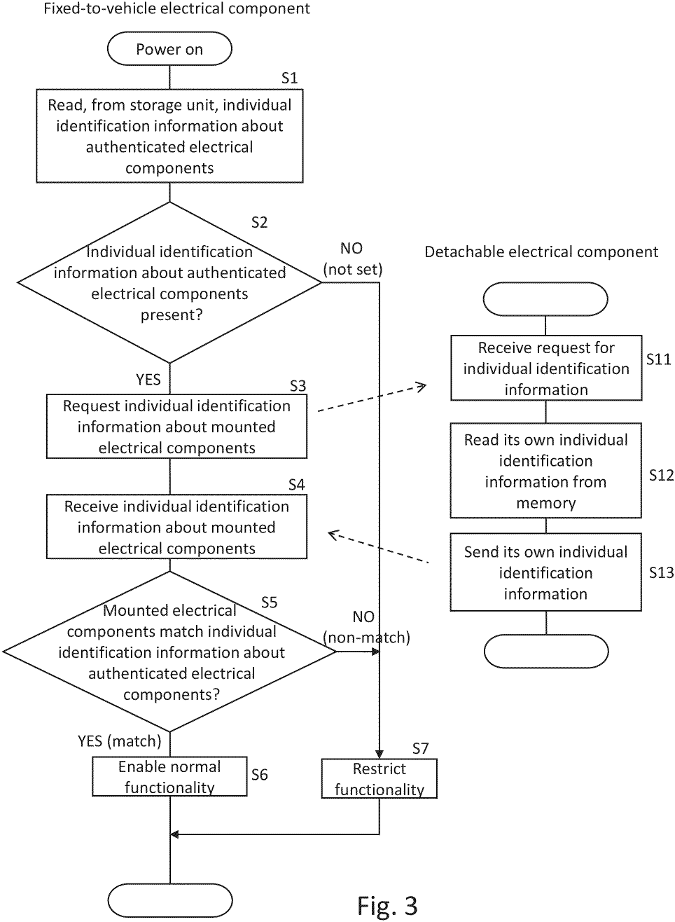

FIG. 3 is a flow chart illustrating an exemplary operation of the on-board system 100 shown in FIG. 2. By way of example, FIG. 3 is a flow chart for an implementation where a fixed-to-vehicle electrical component (e.g., drive unit 40) includes a storage unit 1, an authentication unit 2, and a function range control unit 3. In the implementation of FIG. 3, when the fixed-to-vehicle electrical component is powered on, the authentication unit 2 reads individual identification information about authenticated electrical components from the storage unit 1 (S1).

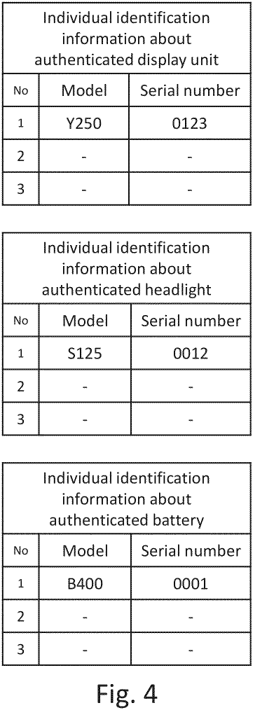

FIG. 4 shows exemplary individual identification information stored in the storage unit 1. In the implementation shown in FIG. 4, the individual identification information contains models and serial numbers for electrical components. A model indicates the device type of an electrical component. A serial number is a specific number uniquely assigned to each of a plurality of products of the same device type. Individual identification information about authenticated electrical components stored in the storage unit 1 is individual identification information about each of the plurality of electrical components mounted on the bicycle 10 (in the present implementation, the battery 35, the display unit 36, and the headlight 37). In the present implementation, no individual identification information about the drive unit 40 is stored. This is because the storage unit 1 and the authentication unit 2 are located in the control device 42 of the drive unit 40, which means that the drive unit 40 is the entity that stores authentication information and performs authentication, and thus the drive unit 40 can be considered to have already been individually identified. It will be understood that the individual identification information is not limited to the example shown in FIG. 4.

Returning to FIG. 3, if individual identification information about authenticated electrical components is stored in the storage unit 1 (YES at step S2), the authentication unit 2 requests individual identification information from each of the other electrical components mounted on the bicycle 10 (e.g., the battery 35, the display unit 36, and the headlight 37) (S3). Each of the other electrical components (i.e., detachable electrical components) receives this request (S11), reads its own individual identification information from its own memory (S12) and sends it to the authentication unit 2 of the fixed-to-vehicle electrical component (S13).

The authentication unit 2 receives the individual identification information about each of the other electrical components (S4). The authentication unit 2 determines whether the individual identification information about the other electrical components matches the individual identification information about authenticated electrical components read from the storage unit 1 (S5). For example, the determination by the authentication unit 2 indicates a match if the individual identification information about all of the other electrical components, when examined on a component-to-component basis, matches the stored individual identification information about the authenticated electrical components (YES at step S5). The determination by the authentication unit 2 indicates a non-match if the individual identification information about one of the other electrical components is not stored as individual identification information about authenticated electrical components (NO at step S5).

If the determination at step S5 is YES (i.e., a match), the function range control unit 3 sets the range of the function implementable by the fixed-to-vehicle electrical component to a predetermined normal range (S6). That is, the function range control unit 3 permits the normal function of the fixed-to-vehicle electrical component. For example, the control device 42 of the drive unit 40 controls the motor 41 so as to output an assist force without any functional restrictions. Thus, the user may use all of the predetermined modes of running or assist functions, for example.

If the determination at step S5 is NO (i.e., a non-match), the function range control unit 3 restricts the range of the function implementable by the fixed-to-vehicle electrical component relative to normal (S7). Further, if no individual identification information about an authenticated electrical component is not stored in the storage unit 1 (NO at step S2), the function range control unit 3 restricts the range of the function implementable by the fixed-to-vehicle electrical component relative to normal (S7). For example, the function range control unit 3 sets the control of the motor 41 by the control device 42 of the drive unit 40 to a restricted range. Examples of functional restrictions include no or restricted assistance by the motor (in pedaling assist, push-walking), or restricting the modes of running to only some of them. This restricts the user-available functionality of a bicycle 10 on which a combination of electrical components that have not be authenticated is mounted. As a result, theft will be deterred.

Details of functional restrictions may be settable by the user. For example, the function range control unit 3 may receive input of commands with details of functional restrictions from the user via the display unit 36.

The function range control unit 3 may also control the ranges of the functions of electrical components other than the electrical component including the authentication unit 2. For example, when the determination of the authentication unit 2 indicates a non-match, the function range control unit 3 may restrict the number of items to be displayed on the display unit 36, or reduce the illumination function of the headlight 37. Further, when the determination indicates a non-match, the function range control unit 3 may enlarge functionality in lieu of restricting functionality. Examples of enlarged functions include redundant functions such as display of an alarm on the display unit 36 or sound output, flashing on and off of the headlight 37, and extra assist by the drive unit 40. Adding redundant functions will make the user hesitant to use a bicycle 10 on which a combination of electrical components that have not been authenticated is mounted.

The implementation shown in FIG. 3 is an example where the fixed-to-vehicle electrical component includes the storage unit 1, the authentication unit 2, and the function range control unit 3. In a variation thereof, the storage unit 1, the authentication unit 2, and the function range control unit 3 may be located in a detachable electrical component (e.g., the display unit 36). In such implementations, the detachable electrical component performs the processes S1 to S7 in FIG. 3, and the other electrical components (including the fixed-to-vehicle electrical component) perform the processes S11 to S13 in FIG. 3.

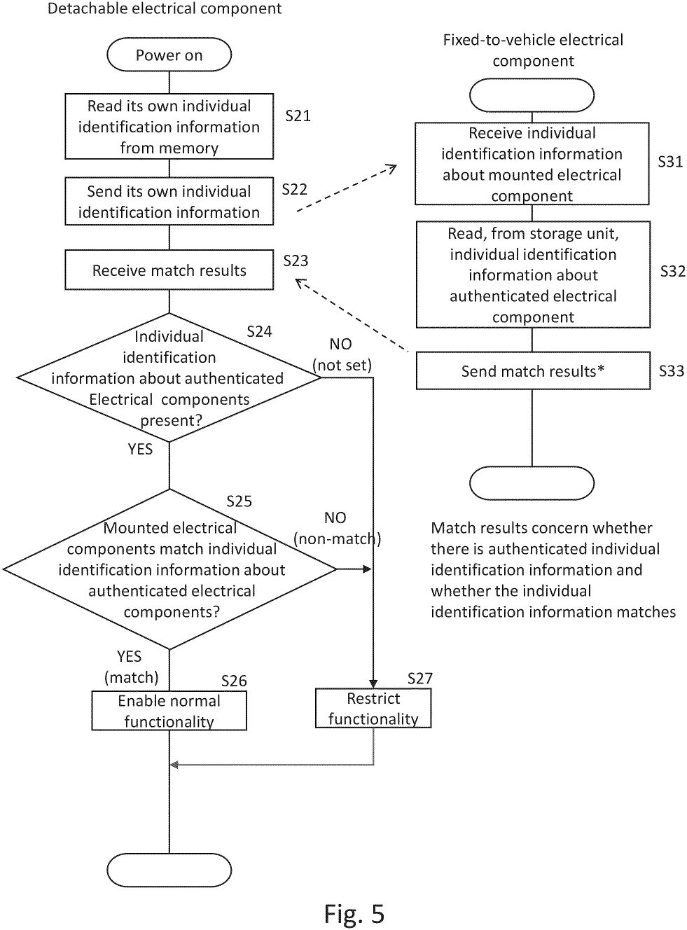

FIG. 5 is a flow chart illustrating another exemplary operation of the on-board system 100 shown in FIG. 2. FIG. 5 is a flow chart of a variation where a detachable electrical component (e.g., the display unit 36) includes an authentication unit 2 and a function range control unit 3, and a fixed-to-vehicle electrical component (e.g., drive unit 40) includes a storage unit 1.

In the implementation shown in FIG. 5, upon power-on, the detachable electrical component reads its own individual identification information from its own memory (S21), and sends it to the fixed-to-vehicle electrical component including the storage unit 1 (S22). The fixed-to-vehicle electrical component receives individual identification information from each of the detachable electrical components and other mounted electrical components (S31). The fixed-to-vehicle electrical component reads from the storage unit 1 individual identification information about the authenticated electrical components (S32) and compares it with the individual identification information received at step S31 (S33). The comparison result is sent to the detachable electrical component. The comparison results contains, for example, information indicating whether the individual identification information about the detachable electrical component and other electrical components received at step S31 matches the individual identification information about authenticated electrical components stored in the storage unit 1 (i.e., a match or a non-match), and information indicating whether there is individual identification information about authenticated electrical components.

The authentication unit 2 of the detachable electrical component obtains the comparison result (S23). Based on the comparison, the authentication unit 2 determines whether there is individual identification information about authenticated electrical components (S24). If YES at step S24, the authentication unit 2 determines, based on the comparison, whether the combination of the electrical components mounted on the bicycle 10 matches the individual identification information about the authenticated electrical components (i.e., a match or a non-match) (S25).

If the determination at step S25 is YES (i.e., a match), the function range control unit 3 sets the range of the function implementable by the detachable electrical component to the predetermined normal range (S26). If the determination at S25 is NO (i.e., a non-match), the function range control unit 3 restricts the range of the function implementable by the detachable electrical component relative to normal (S27). Further, if no individual identification information about an authenticated electrical component is stored in the storage unit 1 (NO at S24), the function range control unit 3 restricts the range of the function implementable by the detachable electrical component relative to normal (S7). It will be understood that the function range control unit 3 may also control the ranges of the functions implementable by other electrical components (e.g., fixed-to-vehicle electrical component). Further, the function range control unit 3 may enlarge the ranges of the functions implementable by electrical components.

In the implementation of FIG. 5, a fixed-to-vehicle electrical component (e.g., drive unit 40) includes the storage unit 1 and the individual identification information about the other electrical components mounted on the bicycle is collected in that electrical component. In a variation thereof, a detachable electrical component (e.g., the display unit 36) may include an authentication unit 2 and the individual identification information about the other electrical components may be collected in that electrical component. In such implementations, the authentication unit 2 receives, from the fixed-to-vehicle electrical component, the individual identification information about authenticated electrical components stored in the storage unit 1. Thus, the authentication unit 2 may determine whether the combination of the electrical components mounted on the bicycle matches the individual identification information about the authenticated electrical components.

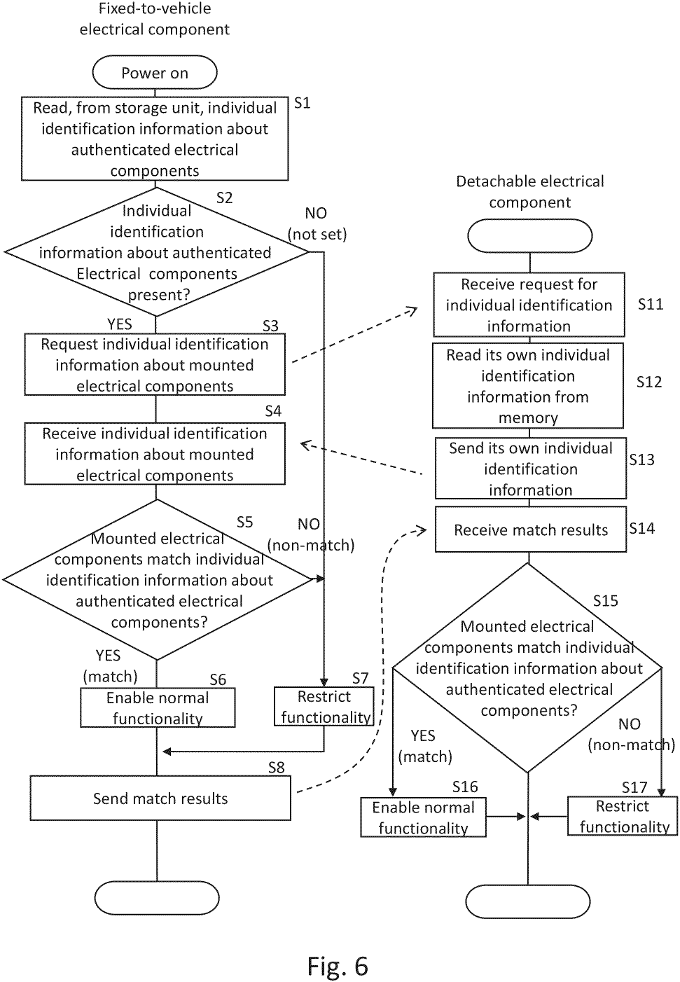

FIG. 6 is a flow chart illustrating another exemplary operation of the on-board system 100 shown in FIG. 2. FIG. 6 is a flow chart for a variation in which the fixed-to-vehicle electrical component (e.g., drive unit 40) includes a storage unit 1, an authentication unit 2, and a function range control unit 3 and the detachable electrical component (e.g., the battery 35) includes an authentication unit 2 and a function range control unit 3. Steps S1 to S7 and S11 to S13 in FIG. 6 are the same as steps S1 to S7 and S11 to S13 in FIG. 3.

At step S8 in FIG. 6, the comparison result from the fixed-to-vehicle electrical component is sent to the detachable electrical component. The comparison result may contain, for example, information indicating whether the individual identification information about the plurality of electrical components mounted on the bicycle 10 matches the individual identification information about the authenticated electrical components (i.e., a match or a non-match), and information indicating whether there is individual identification information about authenticated electrical components. The authentication unit 2 of the detachable electrical component receives the comparison result (S14) and, based on the comparison, determines whether the result is a match or a non-match (S15). If the determination at step S15 is YES (i.e., a match), the function range control unit 3 sets the range of the function implementable by the detachable electrical component to a predetermined normal range (S16). If the determination at step S15 is NO (i.e., a non-match), the function range control unit 3 restricts the range of the function implementable by the detachable electrical component relative to normal (S17).

Thus, the authentication units 2 and the function range control units 3 may be located in a plurality of electrical components. For example, if the detachable electrical component in FIG. 6 is the battery 35, the memory of the battery 35, which can constantly receive power supply, may be a volatile memory (e.g., DRAM). Further, to give an example of how to control the function range of the battery 35, the function range control unit 3 may set a maximum output current of the battery 35. In such implementations, the battery 35 may notify the drive unit 40 of the maximum current permitted to be used. The control device 42 of the drive unit 40 may adjust the motor output within the range of which it has been notified. As the battery 35 restricts the maximum current to be used to a low level, the motor output of the drive unit 40 is restricted. In this implementation, the output of the battery 35 is restricted if it has been determined that the combination of the individual identification information held by the battery 35 and the individual identification information about the other electrical components mounted on the bicycle 10 does not match the individual identification information about the authenticated components. As a result, the function of the drive unit 40 will be restricted.

As in the above-described implementation, the battery 35 may include an authentication unit 2 and a function range control unit 3. The battery 25 may also include a battery control unit that controls the output power. The function range control unit 3 may control the range of the function of the battery control unit. By way of example, the battery 35 may include one or more cells and a battery management system (BMS) that controls input and output of power into and from the cell(s) depending on the voltage and temperature of the cell(s). In such implementations, the battery control unit may be included in the BMS. The authentication unit 2 and the function range control unit 3 may be included in the BMS, or may include a computer or a circuit connected to the BMS.

The storage unit(s) 1, the authentication unit(s) 2, and the function range control unit(s) 3 in a plurality of electrical components are not limited to the above-described exemplary embodiments. A storage unit 1, an authentication unit 2, and a function range control unit 3 may be located in at least one of a fixed-to-vehicle electrical component or a detachable electrical component.

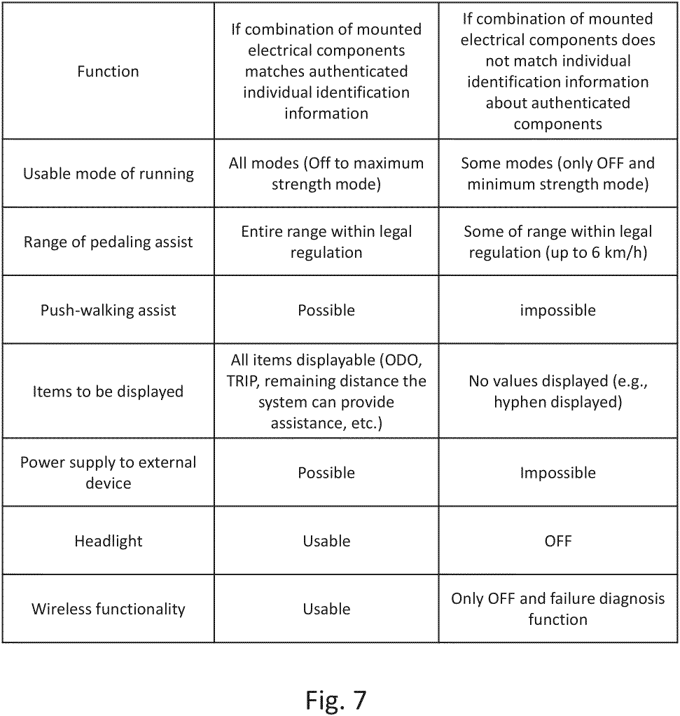

FIG. 7 illustrates how the ranges of functions may be controlled by the function range controller 3. As shown in the implementation of FIG. 7, the function ranges of the drive unit 40 to be controlled may be, for example, at least one of the variety of available modes of running, a range of pedaling assist by the motor 41, or whether push-walking assist is available. Further, the function ranges of the display unit 36 to be controlled may be the number of items to be displayed relating to the state of the bicycle. Power supply function for an external device means the ability of an electrical component to supply electric power to an external device through a connection port on the external component to which a power supply line for the external device can be connected. For example, a connection port may be provided on the display unit 36, the drive unit 40, or the battery 35. The function range control unit 3 may control whether power is to be supplied to an external device via the connection port, or control the amount of power supply. Wireless function means the ability of an electrical component and an external device to communicate wirelessly. For example, the function range control unit 3 may control whether wireless communication between the battery 35, the display unit 36, or the drive unit 40 and an external device is to be permitted, or control the communication performance. Thus, the ranges of the plurality of functions of the bicycle 10 implementable by the plurality of electrical components mounted on the bicycle 10 are controlled so as to vary depending on whether the combination of the plurality of electrical components is authenticated or not. It will be understood that the control of the ranges of functions by the function range control unit 3 is not limited to the above-described examples.

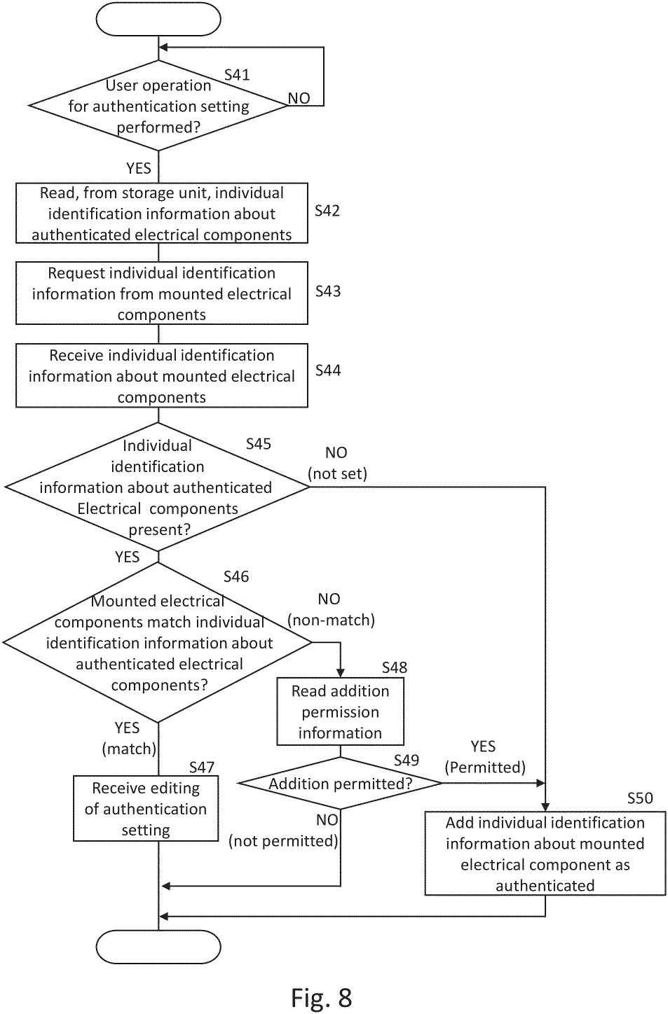

FIG. 8 is a flow chart illustrating an exemplary operation of the authentication setting unit 4 of the on-board system 100 shown in FIG. 2. In the implementation of FIG. 8, when a predetermined user operation for authentication is detected (YES at step S41), the authentication setting unit 4 initiates the process for authentication. The authentication setting unit 4 reads individual identification information about authenticated electrical components from the storage unit 1 (S42). Further, the authentication setting unit 4 requests individual identification information from the electrical components mounted on the bicycle 10 (S43), and receives the individual identification information from the electrical components (S44).

The authentication setting unit 4 determines whether individual identification information about authenticated electrical components is stored in the storage unit 1 (S45). That is, the authentication setting unit 4 determines whether individual identification information about authenticated electrical components have already been set. If NO at step S45, i.e., no information has been set, the authentication setting unit 4 records in the storage unit 1 the individual identification information about the electrical components that are mounted at this time as individual identification information about authenticated electrical components (S50). That is, the authentication setting unit 4 records in the storage unit 1 the individual identification information received at step S44 as individual identification information about authenticated electrical components. Thus, when the bicycle 10 is in the initial state upon shipment or has returned to the initial state following deletion of the authentication information (i.e., a reset), for example, the user may perform a predetermined operation to set the electrical components being mounted as authenticated electrical components.

If YES at step S45 (i.e., information is already set), the authentication setting unit 4 determines whether the individual identification information about the mounted electrical components received at step S44 matches the individual identification information about the authenticated electrical components (i.e., a match or a non-match) (S46). That is, the unit determines whether the combination of the mounted electrical components is an authenticated combination. If the determination at step S46 is YES (i.e., a match), the authentication setting unit 4 is ready to receive from the user an operation to edit authentication settings (S47).

For example, the authentication setting unit 4 displays on the display unit 36 a screen for receiving editing operations. Examples of editing operations that can be received by the authentication setting unit 4 include deletion of individual identification information about an authenticated electrical component that has already been set, i.e., resetting of authentication information.

Further, the authentication setting unit 4 may receive from the user a setting to permit or prohibit addition of a new authenticated electrical component. When the authentication setting unit 4 receives from the user an operation to set permission of addition, the unit changes the state regarding authentication to an addition-permitting state. For example, the authentication setting unit 4 records in the storage unit 1 information indicating that it is in the addition-permitting state. When the authentication setting unit 4 receives from the user an operation to set prohibition of addition, the unit changes the state regarding authentication to an addition-prohibiting state. For example, the authentication setting unit 4 records in the storage unit 1 information indicating that it is in the addition-prohibiting state.

If the determination at step S46 is NO (i.e., a non-match), the authentication setting unit 4 reads, from the storage unit 1, information indicating permission/prohibition of addition of a new authenticated electrical component (i.e., addition permission information) (S48). If the addition permission information indicates that addition is permitted (YES at step S49), the authentication setting unit 4 records in the storage unit 1 the individual identification information about the electrical components that are mounted at this time as individual identification information about authenticated electrical components (S50). If the addition permission information indicates that addition is prohibited (NO at step S49), the authentication setting unit 4 does not record in the storage unit 1 the individual identification information about the new electrical component as individual identification information about an authenticated electrical component. This will allow additional electrical components to be authenticated based on a condition that the user performs an addition permission operation when a combination of authenticated electrical components have been mounted.

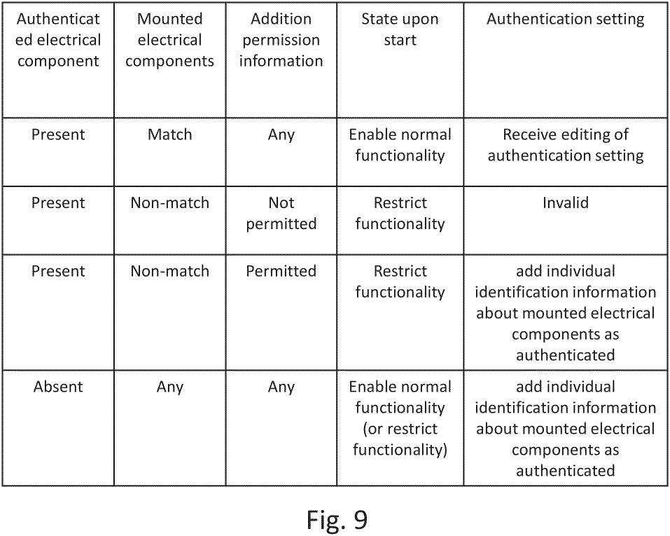

FIG. 9 illustrates the relationship between a condition in the process shown in FIG. 8 and an authentication process. FIG. 9 shows states of authenticated electrical components, mounted electrical components, and addition permission information, and also describes manners in which function ranges are controlled and authentication setting processes associated with these states. In the implementation shown in FIG. 9, editing of an authentication setting is possible if authenticated electrical components have already been set (“present”) and the mounted electrical components have been authenticated, regardless of the addition permission information. If the mounted electrical components do not match the authenticated electrical components, setting a new authenticated electrical component is not possible (i.e., invalid) unless the addition permission information indicates permission. If no authenticated electrical components are present (i.e., not set), setting a new authenticated electrical component is possible regardless of the addition permission information.

As a result of the process shown in FIG. 8, setting of a new authenticated electrical component is restricted if the bicycle 10 is not in the initial state. That is, unless the bicycle is in the initial state, conditions are imposed for recording individual identification information about a new authenticated electrical component. In the above-described implementation, these conditions relate to combined individual identification information about the electrical components mounted on the bicycle 10 and the storage state of individual identification information about authenticated electrical components in the storage unit 1. Such conditions for, i.e., restrictions on, authentication of a new electrical component mean that setting with respect to a stolen electrical component as authenticated and authentication with respect to an electrical component on a stolen bicycle are not easy. This will yet further deter theft.

The operations of the authentication setting unit 4 are not limited to the above-described examples. For example, conditions for setting a new authenticated component are possible that are different from those shown in FIGS. 8 and 9. Further, an authentication setting unit 4 is provided in at least one of the plurality of electrical components. The authentication setting unit 4 may be provided in a fixed-to-vehicle electrical component or in a detachable electrical component. Addition permission information may be stored in the same storage unit 1 that stores individual identification information about authenticated electrical components, or in a different storage device. In the above-described configuration of the authentication setting unit 4, authentication with respect to an electrical component is done by user operation, which eliminates the need to communicate with an external device (e.g., authenticated server) over a network. This enables authentication with respect to an electrical component by user operation without relying on network communication.

The present invention is not limited to the above-described preferred embodiments. For example, the authentication setting unit 4 in FIG. 1 may be omitted. In such implementations, setting of a new authenticated electrical component is not possible by user operation. In such implementations, authentication with respect to an electrical component may be performed by specialized personnel using a dedicated device (i.e., computer with a dedicated application installed and having a dedicated interface), for example.

Electrical components that correspond to the electrical components of the on-board system are not limited to drive units, batteries, display units, operation units, and headlights, as mentioned above. Electrical components may be, for example, on-board sensors such as torque sensors and vehicle-speed sensors or other electronic devices mounted on the bicycle 10.

Preferred embodiments of the present invention are also applicable to an on-board system of a bicycle that is not an electric motor-assisted bicycle. For example, a preferred embodiment of the present invention is also applicable to an on-board system of a bicycle that has no drive unit (i.e., motor).

Preferred embodiments of the present invention are not limited to an on-board system and electrical component that are intended to deter theft. For example, preferred embodiments of the present invention may also be applicable to an on-board system or electrical component that deters unauthorized use or controls the scope of use in a rental service for bicycles or components.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An on-board system comprising:
a plurality of electrical components mounted on a bicycle to perform some functionality of the bicycle; wherein
at least one of the plurality of electrical components includes a storage to store individual identification information about an authenticated electrical component;
at least one of the plurality of electrical components is detachable from the bicycle;
the plurality of electrical components, when mounted on the bicycle, are electrically connected to each other; and
a functionality of the bicycle implementable by at least one of the plurality of electrical components mounted on the bicycle that have been individually identified varies depending on whether a combination of the individually identified electrical components matches the individual identification information about the authenticated electrical component stored in the storage.

2. The on-board system according to claim 1, wherein, if the combination of the plurality of electrical components mounted on the bicycle that have been individually identified does not match the individual identification information about the authenticated electrical component stored in the storage, the functionality of the bicycle implementable by at least one of the plurality of electrical components is restricted relative to that in a case of a match.

3. The on-board system according to claim 1, wherein at least one of the plurality of electrical components includes:
an authenticator to determine whether the combination of the plurality of electrical components mounted on the bicycle that have been individually identified matches the individual identification information about the authenticated electrical component stored in the storage; and
a function range controller to control a range of a function implemented by at least one of the plurality of electrical components based on the determination by the authenticator.

4. The on-board system according to claim 1, wherein at least one of the plurality of electrical components includes an authentication setter to record, in the storage, individual identification information about a new authenticated electrical component when a user has performed a predetermined operation.

5. The on-board system according to claim 4, wherein the authentication setter is operable to control recording, in the storage, of the individual identification information about the new authenticated electrical component based on at least one of the combination of the plurality of electrical components mounted on the bicycle that have been individually identified or the individual identification information about the authenticated electrical component stored in the storage.

6. The on-board system according to claim 5, wherein, if the user has performed the predetermined operation when the individual identification information about the authenticated electrical component was not stored in the storage, the authentication setter is operable to record in the storage the individual identification information about the new authenticated electrical component, and, if the user has performed the predetermined operation when the individual identification information about the authenticated electrical component was stored in the storage, the authentication setter does not permit recording of the individual identification information about the new authenticated electrical component.

7. The on-board system according to claim 5, wherein the authentication setter is operable to permit the storage to update the individual identification information about the authenticated electrical component based on a condition that the user has performed a predetermined setting operation when the combination of the plurality of electrical components mounted on the bicycle that have been individually identified matches the individual identification information about the authenticated electrical component stored in the storage.

8. The on-board system according to claim 1, wherein the plurality of electrical components include at least two of a motor drive, a display to display a state of the bicycle, an operator to receive an input by a user for the bicycle, a headlight, and a battery.

9. A drive for a motor, the drive comprising:
one of the plurality of electrical components in the on-board system according to claim 1; wherein
the drive is operable to vary the functionality of the bicycle implementable by driving of the motor depending on whether the combination of the plurality of electrical components mounted on the bicycle that have been individually identified matches the individual identification information about the authenticated electrical component stored in the storage.

10. A display for displaying a state of a bicycle, the display comprising:
one of the plurality of electrical components in the on-board system according to claim 1; wherein
the display is operable to vary the functionality of the bicycle implementable by at least one of the plurality of electrical components depending on whether the combination of the plurality of electrical components mounted on the bicycle that have been individually identified matches the individual identification information about the authenticated electrical component stored in the storage.

11. A battery comprising:
one of the plurality of electrical components in the on-board system according to claim 1; wherein
the battery is operable to vary electric power to be supplied to at least one of the plurality of electrical components depending on whether the combination of the plurality of electrical components mounted on the bicycle that have been individually identified matches the individual identification information about the authenticated electrical component stored in the storage.
